(19) United States
(12) Patent Application Publication
(10) Pub. No.: US 2025/0323311 A1
(43) Pub. Date: Oct. 16, 2025

(54) SOLID ELECTROLYTE AND SOLID STATE BATTERY COMPRISING THE SAME

(71) Applicant: LG ENERGY SOLUTION, LTD., Seoul (KR)

(72) Inventors: Sung Hyun NAM, Daejeon (KR); Dong Kyu KIM, Daejeon (KR)

(21) Appl. No.: 18/999,896

(22) Filed: Dec. 23, 2024

(30) Foreign Application Priority Data
Apr. 11, 2024 (KR) 10-2024-0048815

(51) Int. Cl. H01M 10/056; H01M 10/0585

(52) U.S. Cl. CPC H01M 10/056; H01M 10/0585; H01M 2300/0071; H01M 2300/0082; H01M 2300/0091

(57) ABSTRACT

A solid electrolyte and an all-solid-state battery containing the solid electrolyte are provided. The electrolyte includes a polyethylene oxide-based copolymer having a branched structure; a lithium salt, and a ceramic compound where the lithium salt and the ceramic compound are dispersed in the polyethylene-oxide based copolymer. The ceramic compound can include an oxide-based solid electrolyte comprising lithium metal oxide or lithium metal phosphate.

### REFERENCE TO RELATED APPLICATIONS

The present application claims priority to and the benefit of Korean patent application no. KR 10-2024-0048815 filed on Apr. 11, 2024, the entire contents of which are incorporated herein by reference.

### TECHNICAL FIELD

Aspects of the present invention relate to a composite solid electrolyte and an all-solid-state battery containing the same.

### BACKGROUND ART

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

Lithium-ion batteries that use a liquid electrolyte have a structure in which the cathode and anode are separated by a separator, so if the separator is damaged by deformation or external impact, a short circuit may occur, which can lead to risks such as overheating or explosion. Therefore, the development of a solid electrolyte that can ensure safety in the field of lithium-ion secondary batteries can be said to be a very important task.

Lithium secondary batteries using solid electrolytes have the advantage of increasing the safety of the battery, improving the reliability of the battery by preventing electrolyte leakage, and making it easy to manufacture thin batteries. In addition, lithium metal can be used as a negative electrode, which can improve energy density. Accordingly, it is expected to be applied to small secondary batteries as well as high-capacity secondary batteries for electric vehicles, and is attracting attention as a next-generation battery.

Among solid electrolytes, polymer solid electrolytes can be made of ion-conducting polymer materials, and can be used in the form of a composite solid electrolyte that mixes these polymer materials with inorganic materials.

Such a conventional hybrid (composite) solid electrolyte is prepared by dispersing an inorganic powder such as an oxide-based ceramics in a polymer matrix, and has the advantage of having higher ignition and combustion stability compared to existing liquid electrolytes, and having higher ionic conductivity than polymer solid electrolytes, but has difficulty in fulfilling certain basic prerequisites, such as improving the dispersibility of oxide-based ceramic particles in the polymer matrix and optimizing the physical properties of the polymer matrix being. In particular, when a highly crystalline polymer such as polyethylene oxide (PEO) or polypropylene oxide (PPO) is used as a matrix, ad problem can arise in that it is difficult to prepare a composite solid electrolyte with improved ionic conductivity. In other words, due to the high crystallinity of PEO or PPO-based polymers, the chain mobility of the polymer is inhibited, the dispersibility of the oxide-based ceramics, etc. is reduced, and movement of lithium ions within the composite solid electrolyte is inhibited. Because of these restrictions, there have been limits on the extent to which the ionic conductivity of composite solid electrolytes can be improved.

In order to overcome the limitations of the conventional composite solid electrolyte, attempts have been made to modify the structure of the crystalline polymer or add a separate plasticizer to the polymer to improve the mobility of the polymer chain and enhance the ionic conductivity of the composite solid electrolyte, but such structural deformation of polymers and addition of plasticizers alone is not sufficient to readily improve the ionic conductivity of the composite solid electrolyte. However, the composite solid electrolyte prepared by using such structural deformation of polymers and addition of plasticizers may be difficult to improve the ionic conductivity above the 0.1 mS/cm level.

In addition, when using a block copolymer containing polypropylene oxide (PPO) units as the polymer matrix, since these polymer matrix may be prepared in the gas phase, and a composite solid electrolyte is formed through gas phase/liquid phase reaction, the overall electrolyte manufacturing process can become complicated, and problems can arise during the process, such as difficulty controlling the thickness of the solid electrolyte membrane. Since the PPO-based polymer matrix may also have a high shrinkage rate during molding and poor impact resistance at low temperatures, the composite solid electrolyte manufactured using this polymer matrix may also have insufficient physical properties.

### SUMMARY

Aspects of the present disclosure provide an electrolyte that exhibits improved ionic conductivity, such as by more uniformly dispersing ceramic compounds and lithium salts in a polymer, and that may be manufactured through a simple process, as well as other benefits and advantages that will be apparent to those persons skilled in the art based on the present disclosure. The present disclosure also includes a solid electrolyte, a composite electrolyte, as well as a composite solid electrolyte, formed with the inventive electrolyte. In addition, the present dislosure includes a method for making the inventive electrolyte, as well as an all-solid-state battery incorporating the electrolyte exhibiting improved ionic conductivity and other beneficial properties and functionality

It should be understood that the various individual aspects and features of the present disclosure herein can be combined with any one or more individual aspect or feature, in any number, to form embodiments of the present disclosure that are specifically contemplated and encompassed by the present disclosure. This includes any combination of the various features recited in the claims, regardless of their stated dependencies.

According to one embodiment, an electrolyte is provided that comprises: a polyethylene oxide-based copolymer having a branched structure comprising repeating units of the following formulas 1 and 2; a lithium salt; and a ceramic compound, wherein the lithium salt and the ceramic compound are dispersed in the polyethylene oxide-based copolymer:

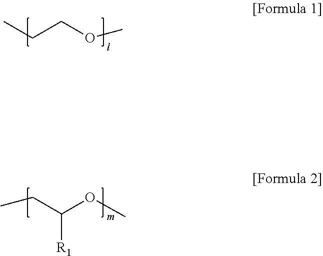

wherein in Formulas 1 and 2, R₁ represents —CH ₂—O—(CH ₂—CH ₂—O )ₖ—R ₃, k is 1 to 20, and R₃ represents an alkyl group having 1 to 5 carbon atoms, and
1 and m are the number of repetitions of the repeating units, where 1 and m are each independently an integer from 1 to 100,000.

The ceramic compound can include an oxide-based solid electrolyte comprising lithium metal oxide or lithium metal phosphate. In certain embodiments, the ceramic compound comprises at least one oxide-based solid electrolyte selected from the group consisting of: a lithium-lanthanum-zirconium oxide (LLZO) compound, a lithium-silicon titanium phosphate (LSTP) compound, a lithium-lanthanum-titanium oxide (LLTO) compound, a lithium-aluminum-titanium phosphate (LATP) compound, a lithium-aluminum-germanium phosphate-based (LAGP) compound, and a lithium-lanthanum-zirconium-titanium oxide-based (LLZTO) compound. The lithium salt can be contained in an amount of 10 to 40 parts by weight based on 100 parts by weight of the copolymer. In one embodiment, the ceramic compound can be included in an amount of 5 to 50 parts by weight based on 100 parts by weight of the copolymer. In one embodiment, the ceramic compound is included in an amount of no more than 40 parts by weight based on 100 parts by weight of the copolymer, such as 20 to 40 parts by weight based on 100 parts by weight of the copolymer, or 30 to 40 parts by weight based on 100 parts by weight of the copolymer. In one embodiment, the electrolyte comprises an ionic conductivity of at least 3.6×10 ⁻⁵ S/ [symbol] , or at least 7.8×10⁻⁵ S/cm at 25° C. The polyethylene oxide-based copolymer can be non-crosslinked. The ceramic compound can comprise particles having a diameter of 100 nm to 1000 nm. The electrolyte can be in the form of a dry film. The weight average molecular weight (Mw) of the polyethylene oxide-based copolymer may be from 100,000 g/mol to 4,000,000 g/mol.

In one embodiment, the polyethylene oxide-based copolymer has a branched structure according to formula 1a:

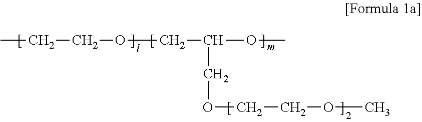

In one embodiment, a method for producing an electrolyte comprises forming a mixed solution including: a polyethylene oxide-based copolymer having a branched structure containing repeating units of the following formulas 1 and 2; a lithium salt; and a ceramic compound; applying the mixed solution onto a substrate, and drying the mixed solution

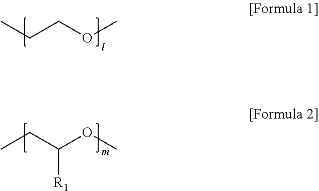

wherein in Formulas 1 and 2, R ₁ represents —CH ₂—O—(CH ₂—CH ₂—O ) ₖ—R ₃, k is 0 to 20, and R 3 represents an alkyl group having 1 to 5 carbon atoms, and 1 and m are the number of repetitions of the repeating unit, where 1 and m are each independently an integer from 1 to 100,000.

In one embodiment, an electrolyte formed by the above method is provided.

In one embodiment, an all-solid-state battery is provided that comprises an electrolyte layer containing the electrolyte as described herein. The all-solid-state battery can comprise: a positive electrode containing a positive electrode active material; a negative electrode containing a negative electrode active material; and the electrolyte layer interposed between the positive electrode and the negative electrode.

According to certain embodiments, the electrolyte may be capable of dispersing a ceramic compound and a lithium salt in a non-crosslinked PEO-based polymer matrix having a branched structure, and the ceramic compound can be uniformly distributed without agglomeration between each component or agglomeration of particles. As a result, by reducing the influence of crystallinity of linear polymers, the ceramic compounds can be uniformly dispersed, thereby exhibiting improved ionic conductivity.

In addition, according to certain embodiments, due to the excellent dispersibility of the polymer matrix, electrolyte can be manufactured by a simplified process of mixing each component in a liquid state and then casting it to prepare a film state, thereby exhibiting excellent processability and mass production.

### DETAILED DESCRIPTION

Further aspects, features and advantages of the disclosure will become apparent from the detailed description which follows.

As used herein, the singular forms “a”, “an” and “the” are intended to include the plural forms as well, unless the context clearly indicates otherwise. Additionally, the use of “or” is intended to include “and/or”, unless the context clearly indicates otherwise.

All of the numerical values referenced herein should be interpreted as also being modified by the term “about.” As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of a composition or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the endpoints of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the inclusive sense of “and/or” and not the exclusive sense of “either/or.”

Technical and scientific terms used herein have the meaning commonly understood by one of skill in the art to which the present description pertains, unless otherwise defined. Reference is made herein to various methodologies and materials known to those of skill in the art.

Unless a specific methodology provided, the various properties and characteristics disclosed herein are measured according to conventional techniques familiar to those skilled in the art.

Previously, in order to improve the ionic conductivity of a solid electrolyte, a composite solid electrolyte was manufactured by mixing a ceramic compound such as an oxide or a lithium salt with a polymer matrix having a cross-linked structure. However, such composite solid electrolyte consists of oxide-based ceramic particles within the polymer matrix. When the ceramic particles are distributed unevenly or when a polymer containing highly crystalline units such as polyethylene oxide or polypropylene oxide is used, a problem can arise in that the dispersibility and ionic conductivity of the ceramic compound can decrease. Specifically, as agglomeration occurs between particles of the ceramic compound, the ability to improve the ionic conductivity of the electrolyte may be limited.

Accordingly, as described herein, according to certain embodiments, a polyethylene oxide-based copolymer, which may have a branched and non-crosslinked structure containing specific units, can be mixed in solution with a ceramic compound and a lithium salt, and then applied onto a substrate and dried to form a film having a uniform distribution of the ceramic compound (and lithium salt) between the polymer chains. Accordingly, an electrolyte can be prepared according to this process, such as a composite solid electrolyte containing dispersed polymers. According to certain embodiments, the polymer matrix formed according to this method can exhibit excellent dispersibility for ceramic compounds and/or lithium salts, and as a result, even without the use of separate plasticizers or dispersants, a simple process can be provided that makes it possible to manufacture an electrolyte that exhibits excellent ionic conductivity. Furthermore, according to certain embodiments, the composite solid electrolyte as described herein exhibits improved ionic conductivity compared to existing composite solid electrolytes, and can be manufactured and provided through a simplified process.

Hereinafter, the electrolyte, which according to one embodiment may be composite solid electrolyte, will be described in detail.

### Solid Electrolyte

A solid electrolyte according to embodiments of the disclosure can include composite solid electrolyte. In one embodiment, the composite solid electrolyte according to an embodiment of the disclosure includes a polyethylene oxide-based copolymer having a branched structure, and which may be a non-crosslinked copolymer. The composite solid electrolyte according to certain embodiments can further comprise a lithium salt and a ceramic compounds that are dispersed in the copolymer.

In one embodiment, the polyethylene oxide-based copolymer having the branched structure does not have any cross-linkable functional group. At least some of the polyethylene oxide-based repeating units have a branched chain containing an alkylene oxide repeating structure. The structure of this branched chain may be, for example —CH ₂—O—(CH ₂—CH ₂—O ) ₖ—R ₃ (where k is 0 to 20, such as 1 to 20, and R ₃ is an alkyl group having 1 to 5 carbon atoms). These branched chains may be bonded to the main chain of the polyethylene oxide-based copolymer, such by being bonded to at least some of the polyethylene oxide-based repeating units. In one embodiment, polyethylene oxide-based copolymer does not contain additional polymer units other than polyethylene oxide-based repeating units. For example, in one embodiment, the polyethylene oxide-based copolymer does not contain any polypropylene oxide-based repeating units.

In one embodiment, the structure of the copolymer is configured such that the branched chains can act as a kind of plasticizer, which can help promote the uniform dispersion of ceramic compounds in the copolymer. As a result, according to certain aspects, the composite solid electrolyte may be produced without requiring the use of additional additives such as separate plasticizers or dispersants. Furthermore, according to certain embodiments, excellent ionic conductivity can be achieved even when using only a relatively small amount of ceramic compound. Also, according to certain embodiments, as the copolymer does not require the incorporation of additional polymer units, such as polypropylene oxide-based systems, excellent physical properties can be maintained, such as excellent impact resistance of the composite solid electrolyte.

In one embodiment, the polyethylene oxide-based copolymer having the branched structure may be a copolymer containing repeating units of the following formulas 1 and 2:

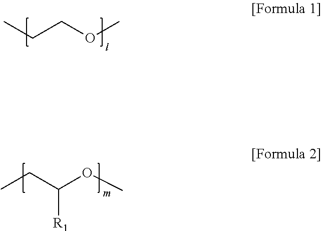

In Formulas 1 and 2, R₁ represents —CH₂—O—(CH₂—CH₂—O)ₖ—R₃, k is 0 to 20 (such as 1 to 20), and R ₃ represents an alkyl group having 1 to 5 carbon atoms,
1 and m are the number of repetitions of the repeating unit and are each independently an integer of 1 to 100,000, 50 to 80,000, or 100 to 5,0000.

According to one embodiment, the polyethylene oxide-based copolymer having the branched structure comprises repeating units that consist of the Formulas 1 and 2 above, or in other words, the copolymer does not have repeating units that are other than those in Formula 1 or 2 above. Furthermore, in a case where k is between 1 and 20, the copolymer comprises at least one repeating unit of Formula 2 where R₁ represents —CH₂—O—(CH₂—CH₂-O)ₖ—R ₃, where k can be 1, 2, 3, 4, 5 . . . and any integer up to 20.

According to certain embodiments, the branched chain R₁ may facilitate uniform dispersion of ceramic compounds therein. Accordingly, the composite solid electrolyte, according to one embodiment, can exhibit improved ionic conductivity.

According to one embodiment, the polyethylene oxide-based copolymer has a branched structure according to formula 1a:

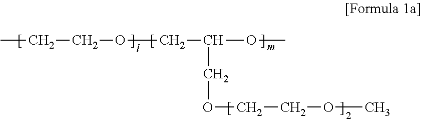

In certain embodiments, when I and m are too small, it may be difficult to form the copolymer due to the small molecular weight, and especially if the repeating unit of Formula 2 is not included, the ionic conductivity of the composite solid electrolyte may be lowered. According to further embodiments, if 1 and m are too large, the solubility may decrease when preparing a solution containing the copolymer due to an increase in viscosity, and it may be difficult to mold the copolymer to produce a solid electrolyte.

According to certain embodiments, the weight average molecular weight (Mw) of the copolymer containing repeating units of Formulas 1 and 2 may be 100,000 g/mol to 4,000,000 g/mol, such as for example 100,000 g/mol or more, 200,000 g/mol or more, or 300,000 g/mol or more, and 3,000,000 g/mol or less, or 2,000,000 g/mol or less. According to certain embodiments, if the weight average molecular weight (Mw) of the copolymer is too small, the mechanical properties of the manufactured solid electrolyte may not be satisfied. According to further embodiments, if the weight average molecular weight (Mw) of the copolymer is too large, the solubility may decrease when preparing a solution of the copolymer due to an increase in viscosity, and it may become difficult to mold the copolymer to produce a solid electrolyte. Additionally, the ionic conductivity of the composite solid electrolyte may decrease due to increased crystallinity and decreased chain mobility inside the solid electrolyte.

According to certain embodiments, the polyethylene oxide-based copolymer may be a random copolymer or a block copolymer.

In one embodiment of the disclosure, the composite solid electrolyte may further include lithium salt. The lithium salt may be contained in a dissociated ionic state in the internal space between polymer chains, and may thereby improve the ionic conductivity of the composite solid electrolyte. According to certain embodiments, at least a portion of the cations and/or anions dissociated from the lithium salt may remain bound to the polymer chain, and mobility can be shown when charging and/or discharging the battery.

According to certain embodiments, the lithium salt can be any of (CF₃ SO₂)₂ NLi(lithium bis(trifluoromethanesulphonyl)imide, LiTFSI), (FSO₂)₂NLi(lithium bis(fluorosulfonyl)imide, LiFSI), LiNO₃, LiOH, LiCl, LiBr, LiI, LiClO₄, LiBF₄, LiB₁₀ Cl₁₀, LiPF₆, LiCF₃ SO₃, LiCF₃ CO₂, LiAsF₆, LiSbF₆, LiAlCl₄, CH₃ SO3 Li, CF₃ SO₃ Li, LiSCN, LiC(CF₃ SO₂)₃, and may also include one or more selected from the group consisting of lithium chloroborane, lithium lower aliphatic carboxylate, and lithium tetraphenyl borate. According to alternative embodiments, the lithium salt may include lithium borate.

According to certain embodiments, the lithium salt may be included in an amount of 10 to 40 parts by weight based on 100 parts by weight of the polyethylene oxide-based copolymer, and specifically, it may be included in an amount of 15 parts by weight or more, or 20 parts by weight or more, or up to 40 parts by weight of the polyethylene oxide-based copolymer. According to certain embodiments, the lithium salt may be included in an amount of less than 38 parts by weight of the polyethylene oxide-based copolymer. According to certain embodiments, if the content of the lithium salt is less than 10 parts by weight, the ionic conductivity of the composite solid electrolyte may decrease, and if the content of the lithium salt exceeds 40 parts by weight, the mechanical strength may decrease.

In one embodiment of the invention, the composite solid electrolyte may include a ceramic compound. The ceramic compound may have a lithium ion transport ability to improve the conductivity of lithium ions, and preferably contains lithium atoms but does not store lithium, and has the function of transporting lithium ions in the composite solid electrolyte, and can thereby improve conductivity of the electrolyte.

Additionally, according to certain embodiments, the ceramic compound may be included in a uniformly dispersed state in the polyethylene oxide-based copolymer having the branched structure. According to certain aspects, the ceramic compound can be uniformly dispersed without agglomeration between polymer chains due to the branched chain structure of the polyme. Such ceramic compounds can be advantageous in improving the mechanical strength and ionic conductivity of composite solid electrolytes due to their uniform dispersion form.

Additionally, according to certain aspects, the ceramic compound may be in particle form. Due to the morphological characteristics of particles, according to certain aspects, they can be contained in a more uniformly dispersed state within the composite solid electrolyte. In one embodiment, the particles of the ceramic compound may be spherical and have a diameter of 100 nm to 1000 nm. According to certain embodiments, if the diameter is less than 100 nm, the non-crystallization effect through reduced crystallinity of the polymer may be minimal, and if it is more than 1000 nm, dispersibility may decrease due to increased aggregation between particles, making it difficult to disperse uniformly.

The ceramic compound may be an oxide-based or phosphate-based compound, for example, an oxide-based solid electrolyte in the form of lithium metal oxide or lithium metal phosphate. More specifically, the ceramic compound may be at least one selected from the group consisting of garnet-type lithium-lanthanum-zirconium oxide (LLZO, Li₇La₃Zr₂O₁₂)-based compound, perovskite-type lithium-lanthanum-titanium oxide (LLTO, Li₃xLa_{2/3-x}TiO₃)-based compound, phosphate-based NASICON type lithium-aluminum-titanium phosphate (LATP, Li₁₊ₓAlₓTi₂₋ₓ(PO₄)₃)-based compound, lithium-aluminum-germanium phosphate (LAGP, Li_{1.5}Al_{0.5}Ge_{1.5}(PO₄)₃)-based compound, lithium-silicon-titanium phosphate (LSTP, LiSiO₂TiO₂(PO₄)₃)-based compound, and lithium-lanthanum-zirconium-titanium oxide (LLZTO)-based compound. More preferably, at least one oxide-based solid electrolyte selected from the group consisting of lithium-lanthanum-zirconium oxide (LLZO), lithium-silicon-titanium phosphate (LSTP), lithium-lanthanum-titanium oxide (LLTO), lithium-aluminum-titanium phosphate (LATP), lithium-aluminum-germanium phosphate (LAGP), and lithium-lanthanum-zirconium-titanium oxide (LLZTO) may be used. One or more types of oxide-based solid electrolytes selected from can be used.

According to certain embodiments, the oxide-based or phosphate-based solid electrolyte generally has an ionic conductivity value of up to 10⁻⁴˜10⁻³ S/cm at room temperature, and has the advantage of being stable in a high voltage region, being stable in air, and thus being easy to synthesize and handle. In one embodiment, the electrolyte comprises an ionic conductivity of at least 3.6×10⁻⁵ S/cm, or at least 7.8×10⁻⁵ S/cm at 25° C.

Further, according to certain embodiments, the ceramic compound does not easily cause combustion or ignition phenomenon even under high temperature conditions of 400° C. or more, and thus has increased high-temperature stability. Therefore, when the composite solid electrolyte contains a ceramic compound, not only the mechanical strength but also the high-temperature stability and ionic conductivity of the composite solid electrolyte can be improved.

In one embodiment, the ceramic compound is included in an amount of 10 to 60 parts by weight based on 100 parts by weight of the polyethylene oxide-based copolymer. According to other embodiments, the ceramic compound can be included in an amount of 5 to 50 parts by weight based on 100 parts by weight of the copolymer. In a further embodiment, the ceramic compound can be included in an amount of no more than 40 parts by weight based on 100 parts by weight of the copolymer, such as 20 to 40 parts by weight based on 100 parts by weight of the copolymer, or 30 to 40 parts by weight based on 100 parts by weight of the copolymer.

According to certain embodiments, if the ceramic compound is included in an amount below the above-mentioned range, the effect of lowering the crystallinity of the polymer and making it amorphous due to the ceramic compound may be reduced, so that the effect of increasing the ionic conductivity of the solid electrolyte is not significant, and the mechanical properties are also degraded.

According to further embodiments, if the ceramic compound is included in an amount that exceeds the above-mentioned range, the ceramic compound may not be uniformly dispersed within the polymer, causing the ceramic compound particles to clump together and aggregate, resulting in the production of a solid electrolyte with reduced ionic conductivity.

According to one embodiment, the composite solid electrolyte may be provided in the form of a dry film that does not contain liquid such as an organic solvent or electrolyte solution, According to certain aspects, in this dry film state, excellent ionic conductivity can be exhibited. As a result, the composite solid electrolyte may be capable of greatly contributing to providing an all-solid-state battery that exhibits excellent electrical properties.

### Method of Manufacture

According to one embodiment, the above-described composite solid electrolyte includes the polyethylene oxide-based copolymer having the branched structure containing repeating units of the formulas 1 and 2, and is prepared by forming a mixed solution containing the copolymer, a lithium salt, and a ceramic compound; applying the mixed solution onto a substrate, and drying the mixed solution. That is, the method of preparing the composite solid electrolyte can include casting and drying the mixed solution and forming it into a film.

According to certain embodiments, due to the excellent dispersibility of ceramic compound and lithium salt in the copolymer, the copolymer can be readily mixed with the ceramic compound to form a solution with the ceramic compound and/or lithium salt dispersed in the copolymer, and the composite solid electrolyte can be produced by a simple method of film forming.

Since the polyethylene oxide-based copolymer having the branched structure has already been described in detail herein, additional explanation thereof will be omitted.

According to one embodiment, the lithium salt and ceramic compound may be the same as those used in the composite solid electrolyte described above, and the amounts may also be the same.

According to one embodiment, the mixed solution containing the polyethylene oxide-based copolymer, lithium salt, and ceramic compound may be applied on a substrate to form a In one embodiment, the mixed solution can be formed by combining the coating film. polyethylene oxide-based copolymer, lithium salt, and ceramic compound, in a solvent, which may be capable of dissolving or dispersing the constituents of the mixed solution.

According to certain embodiments, a solvent used to dissolve the polyethylene oxide-based copolymer and lithium salt and can be easily removed through a drying process. For example, the solvent may be acetonitrile, methanol, ethanol, tetrahydrofuran, water, isopropyl alcohol, dimethyl sulfoxide (DMSO), methylpyrrolidone (NMP, N-Methyl-2-Pyrrolidone) or dimethylformamide (DMF, N,N-Dimethyl formamide).

The concentration of the polymer solution can be appropriately adjusted in consideration of the extent to which the molding process for preparing the polymer solid electrolyte can proceed smoothly. Specifically, the concentration of the polymer solution may mean the concentration (w/w %) of the polymer in the polymer solution. The concentration of the polymer may be the concentration of the PEO-based copolymer. For example, the concentration of the polymer solution may be 5% by weight to 20% by weight, and specifically, it may be 5% by weight or more, 7% by weight or more, or 9% by weight or more, and 13% by weight or less, 17% by weight or less, or 20% by weight or less. If the concentration of the polymer solution is less than 5% by weight, the concentration may be too diluted, and the mechanical strength of the polymer solid electrolyte may decrease, or it may flow down when coated onto a substrate. If the concentration of the polymer solution is more than 20% by weight, it will be difficult to dissolve the lithium salt at the desired concentration in the polymer solution, the viscosity will be high, and the solubility will be low, which makes it difficult to coat the lithium salt in the form of a uniform thin film.

The substrate is not particularly limited as long as it can serve as a support for forming the coating film. For example, the substrate may include SUS (Stainless Use Steel), polyethylene terephthalate film, polytetrafluoroethylene film, polyethylene film, polypropylene film, polybutene film, polybutadiene film, vinyl chloride copolymer film, polyurethane film, ethylene-vinylacetate film, ethylene-propylene copolymer film, ethylene-ethyl acrylate copolymer film, ethylene-methyl acrylate copolymer film, or polyimide film.

Additionally, the method for applying the mixed solution is not particularly limited, as long as a coating film can be formed by applying the mixed solution on the substrate. For example, the application method can include bar coating, roll coating, spin coating, slit coating, die coating, blade coating, comma coating, slot die coating, lip coating, spray coating, or solution casting.

According to one embodiment, the coating film formed on the substrate by the coating method can be molded into a polymer from which the residual solvent is completely removed through a drying process. The drying can be performed separately by a primary drying process and a secondary drying process in order to prevent shrinkage of the polymer due to rapid evaporation of the solvent. The first drying process can remove part of the solvent through room temperature drying, and the secondary drying process can completely remove the solvent through vacuum high temperature drying. The high temperature drying may be performed at a temperature of 80° C. to 130° C. If the high-temperature drying temperature is less than 80° C., the residual solvent cannot be completely removed, and if the high-temperature drying temperature is more than 130° C., the polymer shrinks which makes it difficult to form uniform electrolyte membranes

Accordingly, using the above-described manufacturing method, in certain embodiments a composite solid electrolyte in which a ceramic compound is uniformly dispersed between branched and non-crosslinked polymer chains can be manufactured.

### Solid-State Battery

A further embodiment of the invention also relates to an all-solid-state battery including an electrolyte layer containing the composite solid electrolyte. For example, according to one illustrative embodiment, an all-solid-state battery includes a cathode, an anode, and the previously disclosed electrolyte interposed between the cathode and the anode. The electrolyte may include the composite solid electrolyte disclosed herein.

Specifically, according to one embodiment, the electrolyte is a polyethylene oxide-based copolymer having a branched structure, and contains a lithium salt and a ceramic compound, and where the ceramic compound is uniformly dispersed in the polymer to improve ionic conductivity, and is suitable as an electrolyte for an all-solid-state battery.

Meanwhile, the positive electrode included in the all-solid-state battery includes a positive electrode active material layer, and the positive active material layer may be formed on at least one side of the positive electrode current collector.

According to one embodiment, the positive electrode active material layer includes a positive electrode active material, a binder, and a conductive material.

The positive electrode active material is not particularly limited as long as it is a material capable of reversibly absorbing and desorbing lithium ions, and examples thereof may be a layered compound, such as lithium cobalt oxide, lithium nickel oxide, Li[NixCoyMnzMv]O₂ (where M is any one selected from the group consisting of Al, Ga, and In, or two or more elements thereof; and 0.3≤x<1.0, 0≤y, z≤0.5, 0≤v≤0.1, and x+y+z+v=1), Li(LiaMb-a-b′M′b′)O_{2-c}A_{c}(where 0≤a≤0.2, 0.6≤b≤1, 0≤b′≤0.2, and 0≤c≤0.2; M includes Mn and at least one selected from the group consisting of Ni, Co, Fe, Cr, V, Cu, Zn, and Ti; M′ is at least one selected from the group consisting of Al, Mg, and B; and A is at least one selected from the group consisting of P, F, S, and N), or a compound substituted with at least one transition metal; lithium manganese oxides such as the chemical formula Li_{1+y}Mn_{2-y}O₄ (where y ranges from 0 to 0.33), LiMnO₃, LiMn₂O₃, and LiMnO₂; lithium copper oxide (Li₂CuO₂); vanadium oxides such as LiV₃O₈, LiFe₃O₄, V₂O₅, and Cu₂V₂O₇; Ni-site type lithium nickel oxide expressed by the chemical formula LiNi1-yMyO2 (where Mis Co, Mn, Al, Cu, Fc, Mg, B, or Ga, and y ranges from 0.01 to 0.3); lithium manganese complex oxide expressed by the chemical formula LiMn_{2-y}M_{y}O₂ (where M is Co, Ni, Fe, Cr, Zn, or Ta, and y ranges from 0.01 to 0.1) or Li₂Mn₃MO₈ (where M is Fe, Co, Ni, Cu, or Zn); LiMn₂O₄ having a part of Li being substituted with alkaline carth metal ions; a disulfide compound; and a complex oxide formed of Fe₂(MoO₄)₃, but are not limited thereto.

Further, the positive electrode active material may be included in an amount of 40 to 80% by weight, based on the total weight of the positive electrode active material layer. Specifically, the content of the positive electrode active material may be 40% by weight or more or 50% by weight or more, and 70% by weight or less or 80% by weight or less. If the content of the positive electrode active material is less than 40% by weight, the connectivity and electrical properties between positive electrode active materials may be insufficient, and if the content of the positive electrode active material is more than 80% by weight, the mass transfer resistance may increase.

The binder is a component assisting in binding between the positive electrode active material and the conductive material, and in binding with the current collector. The binder may include at least one selected from the group consisting of styrene-butadiene rubber, acrylic styrene-butadiene rubber, acrylonitrile copolymer, acrylonitrile-butadiene rubber, nitrile butadiene rubber, acrylonitrile-styrene-butadiene copolymer, acrylic rubber, butyl rubber, fluorine rubber, polytetrafluoroethylene, polyethylene, polypropylene, ethylene/propylene copolymer, polybutadiene, polyethylene oxide, chlorosulfonated polyethylene, polyvinylpyrrolidone, polyvinylpyridine, polyvinyl alcohol, polyvinyl acetate, polyepicchlorohydrin, polyphosphazene, polyacrylonitrile, polystyrene, latex, acrylic resin, phenolic resin, epoxy resin, carboxymethylcellulose, hydroxypropyl cellulose, cellulose acetate, cellulose acetate butyrate, cellulose acetate propionate, cyanoethyl cellulose, cyanoethyl sucrose, polyester, polyamide, polyether, polyimide, polycarboxylate, polycarboxylic acid, polyacrylic acid, polyacrylate, lithium polyacrylate, polymethacrylic acid, polymethacrylate, polyacrylamide, polyurethane, polyvinylidene fluoride and poly (vinylidene fluoride)-hexafluoropropene. Preferably, the binder may include at least one selected from the group consisting of styrene-butadiene rubber, polytetrafluoroethylene, carboxymethylcellulose, polyacrylic acid, lithium polyacrylate and polyvinylidene fluoride.

The binder may be included in an amount of 1% by weight to 30% by weight, based on the total weight of the positive electrode active material layer. Specifically, the content of the binder may be 1% by weight or more or 3% by weight or more, and 15% by weight or less or 30% by weight or less. If the content of the binder is less than 1% by weight, the adhesion between the positive electrode active material and the positive electrode current collector may decrease, and if the content of the binder is more than 30% by weight, the adhesion is improved, but the content of the positive electrode active material is reduced accordingly, which may lower battery capacity.

The conductive material is not particularly limited as long as it does not cause side reactions in the internal environment of the battery and does not cause chemical changes in the battery but has excellent electrical conductivity. The conductive material may typically be graphite or electrically conductive carbon, and may be, for example, but is not limited to, one selected from the group consisting of graphite such as natural graphite or artificial graphite; carbon black such as carbon black, acetylene black, Ketjen black, Denka black, thermal black, channel black, furnace black, lamp black, and summer black; carbon-based materials whose crystal structure is graphene or graphite; electrically conductive fibers such as carbon fibers and metal fibers; carbon fluoride; metal powders such as aluminum and nickel powder; electrically conductive whiskers such as zinc oxide and potassium titanate; electrically conductive oxides such as titanium oxide; electrically conductive polymers such as polyphenylene derivatives; and a mixture of two or more thereof.

The conductive material may typically be included in an amount of 0.5% to 30% by weight, based on the total weight of the positive electrode active material layer. Specifically, the content of the conductive material may be 0.5% by weight or more or 1% by weight or more, and 20% by weight or less, or 30% by weight or less. If the content of the conductive material is too low, that is, less than 0.5% by weight, it is difficult to obtain an effect on the improvement of the electrical conductivity, or the electrochemical characteristics of the battery may be deteriorated. If the content of the conductive material too high, that is, more than 30% by weight, the amount of positive electrode active material is relatively small and thus capacity and energy density may be lowered. The method of incorporating the conductive material into the positive electrode is not particularly limited, and conventional methods known in the related art such as coating on the positive electrode active material can be used.

In addition, the positive electrode current collector supports the positive electrode active material layer and serves to transfer electrons between the external conductor and the positive electrode active material layer.

The positive electrode current collector is not particularly limited so long as it does not cause chemical changes in the all-solid-state battery and has conductivity. For example, the positive electrode current collector may be made of copper, stainless steel, aluminum, nickel, titanium, palladium, fired carbon, copper or stainless steel that is surface-treated with one of carbon, nickel, titanium, silver, or the like, an aluminum-cadmium alloy, or the like.

The positive electrode current collector may have a fine protrusion and depression structure layer or may adopt a three-dimensional porous structure in order to improve bonding strength with the positive electrode active material layer. Thereby, the positive electrode current collector may be used in any of various forms including a film, a sheet, a foil, a mesh, a net, a porous body, a foaming body, and a non-woven fabric structure.

The positive electrode as described above can be prepared according to conventional methods. Specifically, the positive electrode can be prepared by a process in which a composition for forming a positive electrode active material layer, which is prepared by mixing a positive electrode active material, a conductive material, and a binder in an organic solvent, is coated and dried on a positive electrode current collector, and optionally, compression molding is performed on the current collector to improve the electrode density. At this time, as the organic solvent, a solvent that can uniformly disperse the positive electrode active material, binder, and conductive material, and that evaporates easily, is preferably used. Specifically, acetonitrile, methanol, ethanol, tetrahydrofuran, water, isopropyl alcohol, dimethyl sulfoxide (DMSO), N-methyl-2-pyrrolidone (NMP), and the like can be mentioned.

Meanwhile, the negative electrode included in the all-solid-state battery includes a negative electrode active material layer, and the negative electrode active material layer may be formed on at least one side of the negative electrode current collector. This negative electrode active material layer can comprise a negative electrode active material, and may contain a conductive material and a binder.

The negative electrode active material may include a material capable of reversible intercalation and deintercalation of lithium (L⁺), a material that can react with lithium ions to reversibly form a lithium-containing compound, lithium metal or lithium alloy.

The material capable of reversibly inserting or de-inserting lithium ions (Li⁺) may be, for example, crystalline carbon, amorphous carbon, or a mixture thereof. The material that can react with the lithium ion (Li⁺) to reversibly form a lithium-containing compound may be, for example, tin oxide, titanium nitrate, or silicon. The lithium alloy includes, for example, lithium (Li), sodium (Na), potassium (K), rubidium (Rb), cesium (Cs), francium (Fr), beryllium (Be), magnesium (Mg), and calcium. It may be an alloy of a metal selected from the group consisting of (Ca), strontium (Sr), barium (Ba), radium (Ra), aluminum (Al), and tin (Sn).

Preferably, the negative electrode active material may be lithium metal, and specifically, may be in the form of a lithium metal thin film or lithium metal powder.

The negative electrode active material may be included in an amount of 40 to 80% by weight, based on the total weight of the negative electrode active material layer. Specifically, the content of the negative electrode active material may be 40% by weight or more or 50% by weight or more, and 70% by weight or less or 80% by weight or less. If the content of the negative electrode active material is less than 40% by weight, the electrical properties may be not sufficient, and if the content of the negative electrode active material is more than 80% by weight, the mass transfer resistance may increase.

The binder may be the same as described above for the positive electrode active material layer.

Further, the conductive material may be the same as described above for the positive electrode active material layer.

The negative electrode current collector is not particularly limited so long as it does not cause chemical changes in the corresponding battery and has conductivity. For example, the negative electrode current collector may be made of copper, stainless steel, aluminum, nickel, titanium, fired carbon, copper or stainless steel that is surface-treated with one of carbon, nickel, titanium, silver, or the like, an aluminum-cadmium alloy, or the like. Further, similar to the positive electrode current collector, the negative electrode current collector may be used in various forms such as a film, a sheet, a foil, a net, a porous body, a foaming body, and a non-woven fabric structure, which fine protrusions and depressions are formed on a surface thereof.

The preparation method of the negative electrode is not particularly limited, and it can be prepared by forming a negative electrode active material layer on a negative electrode current collector using a layer or film forming method commonly used in the art. For example, methods such as compression, coating, and deposition can be used. Further, the negative electrode of the present disclosure also includes a case in which a battery is assembled in a state where a lithium thin film does not exist on the negative electrode current collector, and then a metallic lithium thin film is formed on a metal plate through initial charging.

According to still another embodiment, there is provided a battery module including the all-solid state battery as a unit cell, a battery pack including the battery module, and a device including the battery pack as a power source.

Particular examples of the device may include, but are not limited to power tools driven by an electric motor; electric cars, including electric vehicles (EV), hybrid electric vehicles (HEV), plug-in hybrid electric vehicles (PHEV), or the like; electric carts, including electric bikes (E-bikes) and electric scooters (E-scooters); electric golf carts; electric power storage systems; or the like.

Hereinafter, preferred examples are presented to aid understanding of the invention, but the following examples are provided only to facilitate understanding of the invention and are not intended to limit the invention thereto.

### Example

### Examples 1 to 4: Preparation of Composite Solid Electrolyte

A polyethylene oxide (PEO)-based copolymer of the following formula 1a was prepared:

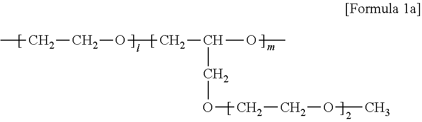

In Formula 1a, The ratio of 1:m is 85:15, The weight average molecular weight (Mw) of the copolymer was about 2,000,000 g/mol.

With acetonitrile used as a solvent, a lithium salt LiTFSI was mixed with the above-mentioned polyethylene oxide copolymer to prepare a polymer solution, and then stirred using a magnetic bar for 24 hours. The above prepared polymer solution was mixed with LSTP as a ceramic compound to prepare a mixture of the polymer and the ceramic compound, and then mixed using a paste mixer at 1500 rpm for 3 minutes, repeating for a total of 5 times. At this time, the composition of the mixture of the non-crosslinked copolymer and the ceramic compound included 36 parts by weight of the lithium salt LiTFSI, and 10 parts by weight of the ceramic compound LSTP (Example 1), 20 parts by weight (Example 2), 40 parts of weight (Example 3) or 60 parts of weight (Example 4) respectively, based on 100 parts by weight of the copolymer. The concentration of the copolymer in the mixed solution was 14.3% by weight, and the amount of acetonitrile solvent was adjusted so that the concentration of the copolymer and ceramic compound was 16.7% by weight. The prepared mixed solution was cast on a coin cell lower substrate, first dried at room temperature for 12 hours, and then secondarily dried in a vacuum oven at 100° C. for 12 hours to form a 200 μm thick layer. An electrolyte film was thus prepared.

### Comparative Examples 1 to 3: Preparation of Composite Solid Electrolyte

A polyethylene oxide (PEO)-based copolymer of the following formula 1b was prepared:

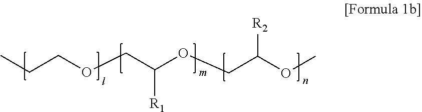

In Formula 1b, R ₁is —CH₂—O—(CH₂—CH2—O)ₖ—CH₃, R₂is —C ₂—O—CH₂—CH═CH₂, k is 2, the ratio of 1:m:n is 85:13:2, The weight average molecular weight (Mw) of the copolymer was about 2,000,000 g/mol.

The copolymer of Formula 1b has an allyl group bonded through a methylene oxide linker as a crosslinkable functional group.

The polyethylene oxide copolymer was mixed with acetonitrile as a solvent, trimethylolpropane trimethacrylate as a crosslinking agent, benzoyl peroxide as an initiator, LiTFSI as a lithium salt, and LSTP as a ceramic compound to form polyethylene oxide copolymer. After preparing a mixture of polymer and ceramic compound, it was stirred using a magnetic bar for 24 hours. At this time, the composition of the mixed solution of the polyethylene oxide copolymer and the ceramic compound is 20 parts by weight of trimethylolpropane trimethacrylate as a crosslinking agent, 1 part by weight of benzoyl peroxide as an initiator, based on 100 parts by weight of polyethylene oxide copolymer, 36 parts by weight of LiTFSI, a lithium salt, and 0 parts by weight of LSTP, a ceramic compound (Comparative Example 1), 10 parts by weight (Comparative Example 2), or 80 parts by weight (Comparative Example 3) were combined, and the mixture of the polymer and the ceramic compound was mixed. An acetonitrile solvent was used so that the concentration of polyethylene oxide copolymer, which is the polymer contained in the mixture, was 11.1% by weight, and the concentration of polyethylene oxide and ceramic compound in the mixture was 14.9% by weight.

The prepared mixture was solution casted on the coin cell lower substrate, first dried at room temperature for 12 hours, and then secondarily dried in a vacuum oven at 100° C. for 12 hours to form a 200μm thick electrolyte film, forming a composite solid. An electrolyte was prepared.

### Experiment Example

### Experimental Example 1: Measurement of Ion Conductivity of Solid Electrolyte

To measure the ionic conductivity of the solid electrolyte prepared in Examples and Comparative Examples, the solid electrolyte was formed on the lower substrate of a coin cell of 1.7671 cm ² and then SUS was used as an inert electrode (blocking electrode) to measure the ionic conductivity. A coin cell for measurement was manufactured.

Resistance was measured using an electrochemical impedance spectrometer (EIS, VM3, Bio Logic Science Instrument) at 25° C. with an amplitude of 10 mV and a scan range of 1 Hz to 0.1 MHz, and then using Equation 1 below: , the ionic conductivity of the solid electrolyte was calculated.

$${σ}_{i} = \frac{L}{RA} \qquad [ Equation 1 ]$$

In Equation 1, σᵢ is the ionic conductivity of the solid electrolyte (S/cm), R is the resistance of the solid electrolyte (Ω) measured with the electrochemical impedance spectrometer, and L is the thickness of the solid electrolyte (μm), A means the area of the solid electrolyte (cm ^{2).}

Table 1 below shows the calculated ionic conductivity values.

TABLE 1

| | Ion conductivity |
|---|---|
| | (S/cm, @25° C.) |
| Example 1 | 7.8 × 10⁻⁵ |
| Example 2 | 2.1 × 10⁻⁴ |
| Example 3 | 1.3 × 10⁻⁴ |
| Example 4 | 3.6 × 10⁻⁵ |
| Comparative | 2.3 × 10⁻⁵ |
| Example 1 | |
| Comparative | 3.6 × 10⁻⁵ |
| Example 2 | |
| Comparative | 1.8 × 10⁻⁵ |
| Example 3 | |

As shown in Table 1, it was confirmed that the composite solid electrolyte of the example prepared using branched polyethylene oxide-based copolymer and a ceramic compound showed improved ionic conductivity compared to the comparative example.

1. An electrolyte comprising:
a polyethylene oxide-based copolymer having a branched structure comprising repeating units of the following formulas 1 and 2;
a lithium salt; and
a ceramic compound,
wherein the lithium salt and the ceramic compound are dispersed in the polyethylene oxide-based copolymer: 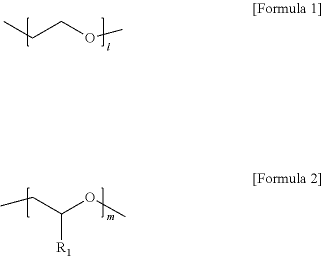
wherein in Formulas 1 and 2, R 1 represents —CH ₂—O—(CH ₂—CH ₂—O) ₖ—R ₃, k is 1 to 20, and R ₃ represents an alkyl group having 1 to 5 carbon atoms, and
1 and m are the number of repetitions of the repeating units, where 1 and m are each independently an integer from 1 to 100,000.

2. The electrolyte of claim 1, wherein the ceramic compound includes an oxide-based solid electrolyte comprising lithium metal oxide or lithium metal phosphate.

3. The electrolyte of claim 1, wherein the ceramic compound comprises at least one oxide-based solid electrolyte selected from the group consisting of: a lithium-lanthanum-zirconium oxide (LLZO) compound, a lithium-silicon titanium phosphate (LSTP) compound, a lithium-lanthanum-titanium oxide (LLTO) compound, a lithium-aluminum-titanium phosphate (LATP) compound, a lithium-aluminum-germanium phosphate-based (LAGP) compound, and a lithium-lanthanum-zirconium-titanium oxide-based (LLZTO) compound.

4. The electrolyte of claim 1, wherein the lithium salt is contained in an amount of 10 to 40 parts by weight based on 100 parts by weight of the copolymer.

5. The electrolyte of claim 1, wherein the ceramic compound is included in an amount of 5 to 50 parts by weight based on 100 parts by weight of the copolymer.

6. The electrolyte of claim 1, wherein the ceramic compound is included in an amount of 20 to 40 parts by weight based on 100 parts by weight of the copolymer.

7. The electrolyte of claim 1, wherein the ceramic compound is included in an amount of 30 to 40 parts by weight based on 100 parts by weight of the copolymer.

8. The electrolyte of claim 1, wherein the electrolyte comprises an ionic conductivity of at least 3.6×10⁻⁵ S/cm at 25° C.

9. The electrolyte of claim 1, wherein the polyethylene oxide-based copolymer is non-crosslinked.

10. The electrolyte of claim 1, wherein the ceramic compound comprises particles having a diameter of 100 nm to 1000 nm.

11. The electrolyte of claim 1, wherein the electrolyte is in the form of a dry film.

12. The electrolyte of claim 1, wherein the polyethylene oxide-based copolymer has a branched structure according to formula 1a:

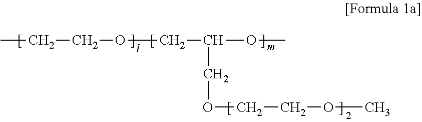

13. The electrolyte of claim 1, wherein the weight average molecular weight (Mw) of the polyethylene oxide-based copolymer is from 100,000 g/mol to 4,000,000 g/mol.

14. An electrolyte comprising:
a polyethylene oxide-based copolymer having a branched structure comprising repeating units consisting of the following formulas 1 and 2;
a lithium salt; and
a ceramic compound,
wherein the lithium salt and the ceramic compound are dispersed in the PEO-based polymer: 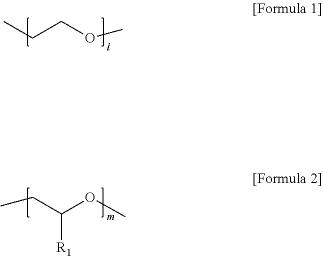
wherein in Formulas 1 and 2, R ₁ represents —CH ₂—O—(CH ₂—CH ₂—O) ₖ —R ₃, k is 0 to 20, and R ₃ represents an alkyl group having 1 to 5 carbon atoms, and
1 and m are the number of repetitions of the repeating unit, where 1 and m are each independently an integer from 1 to 100,000.

15. A method for producing an electrolyte, comprising:
forming a mixed solution including: a polyethylene oxide-based copolymer having a branched structure containing repeating units of the following formulas 1 and 2; a lithium salt; and
a ceramic compound;
applying the mixed solution onto a substrate, and
drying the mixed solution 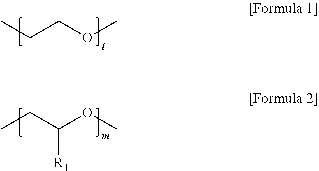
wherein in Formulas 1 and 2, R ₁ represents —CH ₂—O—(CH ₂—CH ₂—O ) ₖ —R ₃, k is 0 to 20, and R 3 represents an alkyl group having 1 to 5 carbon atoms, and
1 and m are the number of repetitions of the repeating unit, where 1 and m are each independently an integer from 1 to 100,000.

16. An electrolyte formed by the method of claim 17.

17. An all-solid-state battery comprising an electrolyte layer containing the electrolyte of claim 1.

18. The all-solid-state battery of claim 19, comprising:
a positive electrode containing a positive electrode active material;
a negative electrode containing a negative electrode active material; and
the electrolyte layer interposed between the positive electrode and the negative electrode.
